(19) United States
(12) Patent Application Publication
(10) Pub. No.: US 2003/0136759 A1
(43) Pub. Date: Jul. 24, 2003

(54) Microlens array fabrication using CMP

(75) Inventor: David G. Mikolas, Rowland Heights, CA (US)

Correspondence Address: Phyllis Turner-Brim, Cabot Microelectronics Corp., 870 Commons Drive, Aurora, IL, 60504, US

(73) Assignee: Cabot Microelectronics Corp.

(21) Appl. No.: 10/192,135

(22) Filed: Jul. 10, 2002

Related U.S. Application Data
(60) Provisional application No. 60/349,513, filed on Jan. 18, 2002.

(51) Int. Cl. C03C 25/68; C03C 15/00

(52) U.S. Cl. 216/26; 216/89

(57) ABSTRACT

Methods for fabricating a variety of microlens array structures on substrates using chemical mechanical polishing techniques.

### BACKGROUND OF THE INVENTION

(1) Field of the Invention

This invention concerns methods for fabricating a variety of microlens structures on polishable substrates using chemical mechanical polishing techniques.

(2) Description of the Art

Microlens arrays have a wide variety of uses in optics including, for example, thin film displays, vision systems, and optoelectronics in CMOs imaging chips and in charge integration devices. The lens arrays of this invention can also be used as lens dies. Current techniques for preparing microlens arrays are based either on diffractive optics, or the post-melting of lithography defined pillars of polymer materials.

U.S. Pat. No. 5,711,890 discloses methods for forming cylindrical lens arrays. Convex lenses arrays are prepared according the '890 patent by patterning a low melting glass layer to form pillars of low melting glass materials and thereafter melting the pillars to form convex surfaces on the cylindrical lens.

Current methods for forming microlens arrays are expensive, offer little ability to closely control the ultimate shape of the microlens surface. In addition, some of the current microlens array formation techniques form lenses which have extreme chromatic abberration and scatter light into different orders. As a result, new and improved methods of forming microlens arrays are needed.

### SUMMARY OF THE INVENTION

In one embodiment, this invention includes methods for manufacturing a microlens arrays. The microlens arrays are manufactured by preparing a substrate including a base layer and a plurality of lens pillars located on top of the base layer wherein a plurality of gaps located between the lens pillars. A buffer material layer is applied to the base layer in an amount sufficient to at least partially fill the gaps between the lens pillars with buffer material, and at least a portion of the buffer layer and material from the lens pillars is removed until at least one lens pillar has a lens surface.

In another embodiment, this invention includes methods for manufacturing microlens arrays. The method of manufacturing microlens arrays begins by preparing a substrate including a base layer and a plurality of lens pillars including gaps located between the lens pillars wherein the lens pillars have exposed surfaces. A buffer material layer is applied to the substrate surface in an amount sufficient to at least partially fill the gaps between the lens pillars. At least a portion of the buffer layer and at least a portion of the lens pillar surface are removed by CMP techniques which include the further steps of: (i) applying a polishing composition to the surface of the buffer layer; and (ii) removing buffer layer from the buffer layer by moving a polishing substrate into contact with the surface of the buffer layer and thereafter moving the polishing substrate in relation to the exposed buffer surface. CMP is continued until a plurality of lens pillars have lens surfaces.

### DESCRIPTION OF THE FIGURES

FIGS. 1A-1F are steps in an embodiment of a process of this invention for preparing an array of microlenses;

FIGS. 2A, 2B and 2C are the intermediate products shown in FIG. 1C with an underfill of buffer layer in FIG. 2A, and an even fill of buffer layer in FIG. 2B and an overfill in buffer layer in FIG. 2C;

FIG. 3 is a cross-section of a lens microarray prepared by the methods of this invention including an antireflective material layer (30) on the side walls of lenses 25.

FIG. 4 is a cross-section view of a lens microarray prepared by the methods of this invention wherein the lenses include filter material layer (27) on the surfaces of lenses (25).

FIG. 5 is a perspective view of an array of lenses that can be prepared using methods of this invention;

FIG. 76 is a perspective view of the topography of a single microlens that can be prepared using methods of this invention wherein the lens focal length of the X axis is different from the lens focal length of the Y axis; and

FIG. 6 is a top view of lens geometries of several microlens arrays that can be prepared by the methods of this invention.

### DESCRIPTION OF THE CURRENT EMBODIMENT

This invention concerns methods for fabricating a microlens array on polishable substrates using chemical mechanical polishing techniques.

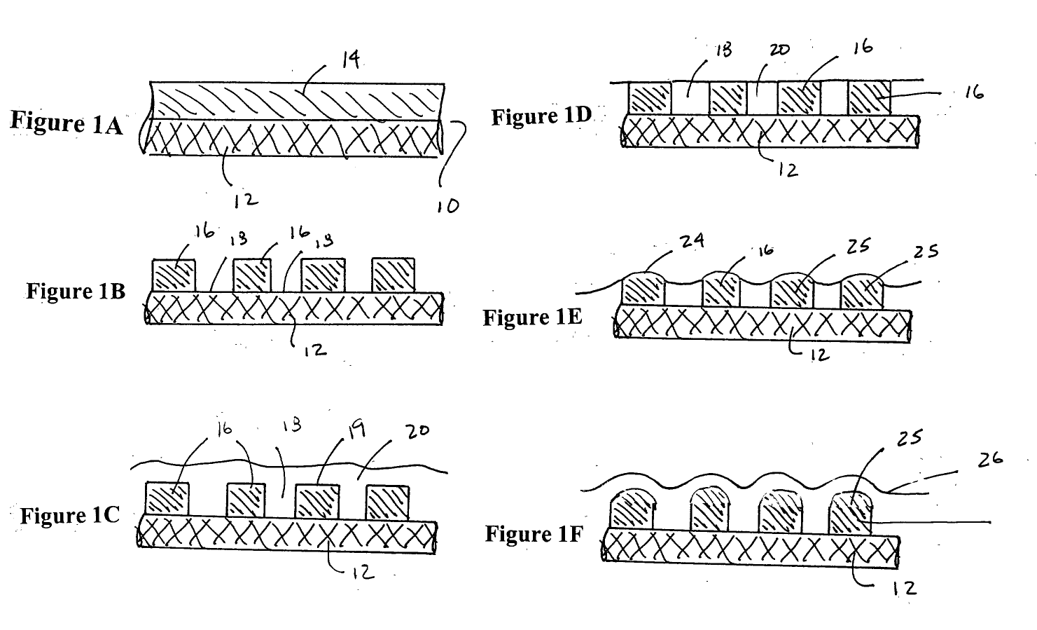

FIGS. 1A-1F are steps in one process of this invention for fabricating a plurality of microlens structures (a microlens array) on a polishable substrate. A starting substrate 10 shown in FIG. 1A is provided. Substrate 10 includes a base layer 12 and a lens material layer 14. Base layer 12 may be any material that can be associated with a microlens array. In one embodiment, base layer 12 may be a transparent substantially inorganic support layer having essentially the same refractive index as lens material layer. In an alternative embodiment, basic layer 12 can be a photo detector array for a CMOs layer. Base layer 12 is preferably an oxide material, that is deposited over an active semi-conductor portion or other materials that may be associated with or connected to a microlens array that are located below base layer 12.

In some cases it may be desirable to manufacture substrate 10 out a base layer 12 and a lens material layer 14 that have different refractive indexes. When materials of different refractive indexes are used, then it may be beneficial to locate a thin antireflective material layer (AR layer) between base layer 12 and lens material layer 14 to equalize the refractive indexes of the two materials.

Lens material layer 14 may be manufactured out of any material that is useful for fabricating an array of lens. Examples of useful lens material layer include, but not limited to, substantially transparent organic materials such as polymers having a high glass transition temperature including, for example, polymethylmethacrylate, polyimide, polycarbonate, as well as other transparent organic materials known in the art. Useful inorganic lens materials include an oxide glass or a material such as silicon, polysilicon, siliconoxynitrate, and doped oxides such as Ge, Er, ZnO, ZrO₂, InP, GaN and so forth.

In FIG. 1B, lens pillars 16 are formed out of lens material layer 14. Lens pillars 16 may be formed by standard lithographic techniques or wet or dry etching techniques that selectively remove a portion of lens material layer 14 to expose base layer 12 and to form gaps 18 between lens pillars 16. Lens pillars 16 may be of any size or shape useful in lens arrays. Generally, lens pillars will have a geometric shape such as a square, circular column, or a rectangle. When lens pillars 16 are rectangular, then the length of the pillar will typically be far greater than the height of lens pillars 16.

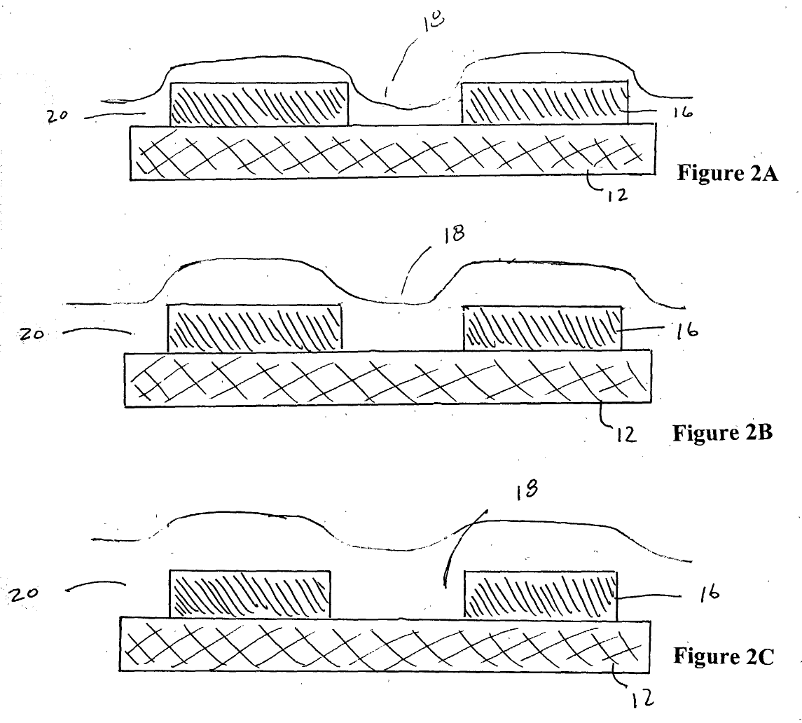

In FIG. 1C, a buffer layer 20 is applied to the surface of substrate 10 in an amount sufficient to at least partially fill gaps 18 between lens pillars 16. Preferably, enough buffer will be applied to substrate 10 to completely fill gaps 18 and to cover surface 19 of each lens pillar 16 as shown in FIG. 1C. However, in some instances, it will be desirable to underfill gaps 18 with buffer material 20 and in some instances it may be desirable to apply buffer material 20 in an amount sufficient to bring the height of buffer material layer to essentially the same height as lens pillar 16. FIGS. 2A, 2B and 2C show intermediate products of the steps shown in FIG. 1C wherein the substrate in FIG. 2A is underfilled with buffer material 20 such that the level of buffer material 20 in gap 18 is below the level of surface 19 of lens pillar 16. In FIG. 2B, the level of buffer material 20 in gaps 18 is essentially equal in height to the surface 19 of lens pillar 16. In FIG. 2C, the substrate is overfilled with buffer material such that the surface of buffer material 20 in gap 18 is located above surface 19 of lens pillar 16. The height of buffer material 20 in gaps 18 will effect the amount of rounding of the lens pillar hedges during chemical mechanical planarization with gradually rounded comers and lens that are overfilled with material 20 producing lens with sharply rounded comers.

Next, at least a portion of buffer layer 20 is removed from substrate 10 as shown in FIGS. 1D and 1E. Buffer layer 20 is preferably removed in a sequential process that slowly exposes surface 19 of lens pillar 16. A preferred method for sequentially removing buffer layer 20 from substrate 10 is by polishing. The polishing may be performed by any polishing method that is capable of sequentially and controllably removing sacrificial layer 20 from substrate 10. Useful polishing methods include manual and mechanical polishing methods. It is preferred that chemical mechanical polishing (CMP) techniques be used to sequentially remove buffer layer 20 from substrate 10.

The buffer material chosen should be a material that is removed from substrate 10 by polishing at a rate faster than the rate at which lens material 14 is removed from lens pillar 16 during the same polishing procedure. The preferential removal of buffer layer 20 in comparison to lens material from lens pillar 16 causes the formation of a convex lens surface 24 to lens pillar 16 during the polishing step as is shown in FIG. 1E.

Generally, buffer layer 20 will be selected from a material that is softer, and therefore easier to polish, in comparison lens material 14. Buffer layer 20 does not always have to be softer than lens material 14. When a polishing composition is used to facilitate the removal of buffer layer 20 from substrate 10, the polishing composition chosen can be one that polishes the buffer layer at a higher rate than it polishes lens material 14. In other words, the polishing composition chosen can have a high polishing selectivity towards buffer layer in comparison to the lens material. In this embodiment, the buffer layer need not be harder than lens material 14. When the desired convex surface profile is achieved on at least one lens pillar 16, a polishing step can be halted. At this point, residual buffer may remain in gaps 18 as shown in FIG. 1E or it can be removed by etching, or by any other techniques known to one of ordinary skill in the art from removing unwanted material from a substrate layer.

In another embodiment of this invention, the step of polishing substrate 10 to form an array of convex lenses 25 is performed in a multi-step polishing process. Is a multi-step polishing process, a first polishing pad or polishing composition is used to quickly remove buffer layer 20 from substrate 10 until the surface of buffer in gaps 18 is essentially co-planar with surface 19 of lens pillar 16. Once the surfaces are essentially co-planar, the polishing pad and/or polishing composition can be changed to selectively polish buffer 20 in comparison to lens material 14 to form convex surfaces 24 on lenses 25.

FIG. 1F shows an optionally embodiment of a product of this invention wherein an optical layer 26 is applied over lens 25. The purpose of optical layer 26 is to assist in focusing or directing light emanating from lens 25 in any manner that might be required by the method in which the lens array is used. Optical layer 26 can be selected from any transparent or semitransparent material that has the required refractive index to direct the light beam that is emitted from lens 25 in the desired manner. The selection of the refractive material is well within the knowledge of one of skilled in the art.

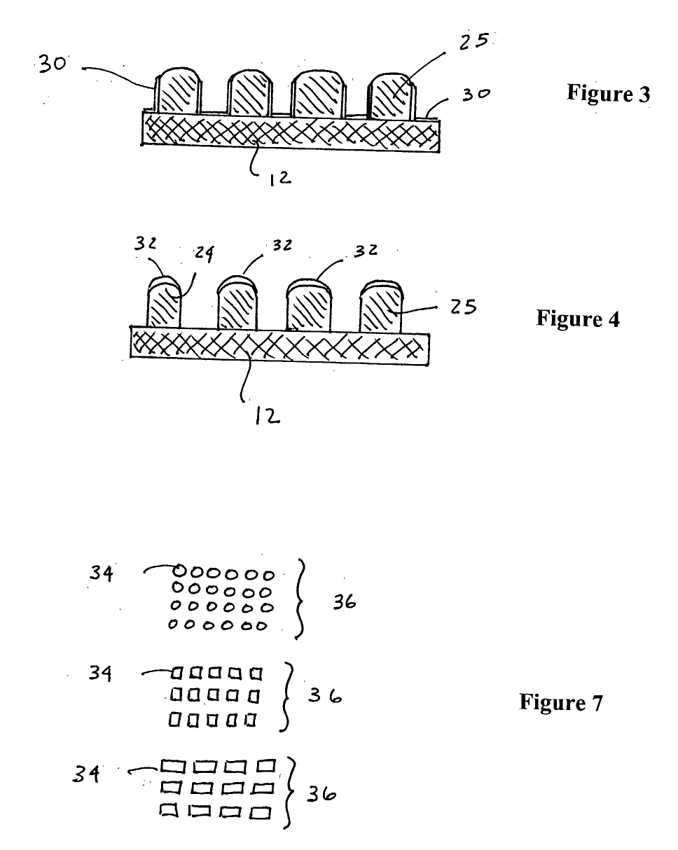

In an alternative process embodiment of this invention, a thin coating of material to prevent light scattering can be applied to the substrate of FIG. 1B prior to the application of buffer layer 20. FIG. 3 is a microlens array that includes such a material layer 30 associated with the side walls of lenses 25 and the surface of base 12 of the microlens array. Material layer 30 can be applied by chemical, vapor or electron beam deposition techniques prior to applying buffer layer 20 to substrate 10. Material layer 30 will typically cover the sides of lens 25 as well as the exposed surface of base layer 12 thereby inhibiting the scatter or loss of light passing through base 12.

In another alternative embodiment, a material layer 32 is applied to convex surface 24 of lens 25 as shown in FIG. 4. Material layer 32 can be any material that is useful on a microarray lens surface such as an antireflective AR (material), a filter material, or a material including a pigment or dye that imports color to while light passing through a lens 25. If material layer 32 is an antireflective material layer, then the antireflective material layer can be chosen from any lens material that has the proper refractive index in comparison to the material used to manufacture lens 25 which causes material layer 32 to be antireflective.

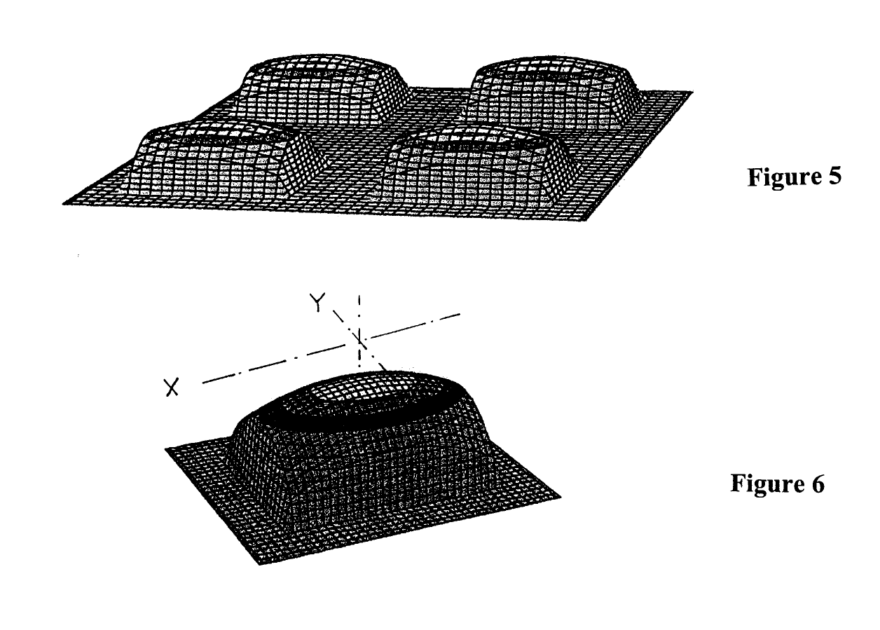

FIG. 5 is a perspective view of an array of four lenses 25 prepared by the methods of this invention. Each lens 25 includes a convex surface 24. FIG. 6 is a close up perspective view of a single lens 25 of this invention. In FIG. 6, the geometry of lens 25 is rectangular. As a result, lens 25 of FIG. 6 has a length in the X-direction that exceeds its width in the Y-direction. This allows the focal length of the lens in the X-direction to differ from the focal length of the lens in the Y-direction.

FIG. 7 is a top view of geometry of some of the lenses 34 that can be used in the lens microarrays 36 that are manufactured by the processes of this invention. Lenses 34 shown in FIG. 6 are circular, rectangular, and square in cross-section and all will have convex surfaces. The geometry of lens pillars 16 can be chosen and designed to impart a particular lens focal length in the X and Y direction upon chemical mechanical polishing of the lens surface as described above.

An important aspect of the processes of this invention is the use of polishing techniques and preferably CMP to controllably remove material from the surface of substrate 10 and to impart a convex shape on the surface of each of the array of lenses. Any procedures that are known to those of skill in the art for controllably removing materials from a surface of a small substrate may be utilized in this invention. It is preferred that polishing processes are used. The polishing process can be hand polishing or mechanical polishing processes. The polishing processes can utilize a polishing substrate such as a cloth or a polishing pad alone or in conjunction with a liquid or aqueous polishing composition. It is most preferred that chemical mechanical polishing techniques are used to remove at least one material or material layer from the substrate during the process of this invention.

In a typical chemical mechanical polishing (CMP) process, the substrate surface that is being polished is placed into contact with a rotating polishing pad. A carrier applies pressure against the backside of the substrate. During the polishing process, the pad and table are rotated while a downward force is maintained against the substrate back. A polishing composition is applied to the interface between the polishing pad and the substrate surface being polished. The polishing composition can be applied to the interface by applying the polishing composition to the polishing pad surface, to the substrate surface being polished or both. The polishing composition can be applied to the interface either intermittently or continuously and the application of the polishing composition can begin prior to or after the polishing pad is brought into contact with the substrate surface being polished. Finally, the term “applying a polishing composition” as it used in the specification and claims is not time limited and refers to the application of a polishing composition either before or after a polishing substrate is moved into contact with the surface being polished.

The polishing composition is formulated to include chemicals that react with and soften the surface of the material being polished. The polishing process further requires an abrasive material to assist in removing a portion of the substrate surface that has been softened by a reaction between the polishing composition and the substrate surface material. The abrasive may be incorporated into the polishing pad such as polishing pads disclosed in U.S. Pat. No. 6,121,143 which is incorporated herein by reference, it may be incorporated into the polishing composition, or both. Ingredients in the polishing composition or slurry initiate the polishing process by chemically reacting with the material on the surface of the substrate that is being polished. The polishing process is facilitated by the movement of the pad relative to the substrate as the chemically reactive polishing composition or slurry is provided to the substrate/pad interface. Polishing is continued in this manner until the desired film or amount of film on the substrate surface is removed.

The movement of the polishing pad in relationship to the substrate can vary depending upon the desired polishing end results. Often, the polishing pad substrate is rotated while the substrate being polished remains stationary. Alternatively, the polishing pad and the substrate being polished can both move with respect to one another. The polishing substrates and in particular the polishing pads of this invention can be moved in a linear manner, they can move in a orbital or a rotational manner or they can move in a combination of the directions. In some instances, it will be desirable to form a noncircular concave cavity in core 12 of single mode fiber 10. Noncircular concave cavities can be formed by for example moving the polishing pad in the x-direction to achieve the desired concave cavity parameters and then optionally moving the pattern in the y-direction until the desired convex cavity parameters are reached.

The choice of polishing composition or slurry is an important factor in the CMP step. Depending on the choice of ingredients such as oxidizing agents, film forming agents, acids, bases, surfactants, complexing agents, abrasives, and other useful additives, the polishing slurry can be tailored to provide effective polishing of the substrate layer(s) at desired polishing rates while minimizing surface imperfections, defects and corrosion and erosion. Furthermore, the polishing composition may be selected to provide controlled polishing selectivities to other thin-film materials used in substrate manufacturing.

Examples of CMP polishing compositions and slurries are disclosed, in U.S. Pat. Nos. 6,068,787, 6,063,306, 6,033,596, 6,039,891, 6,015,506, 5,954,997, 5,993,686, 5,783,489, 5,244,523, 5,209,816, 5,340,370, 4,789,648, 5,391,258, 5,476,606, 5,527,423, 5,354,490, 5,157,876, 5,137,544, 4,956,313, the specifications of each of which are incorporated herein by reference.

While the present invention has been described by means of specific embodiments, it will be understood that modifications may be made without departing from the spirit of the invention. The scope of the invention is not to be considered as limited by the description of the invention set forth in the specification and examples, but rather as defined by the following claims.

What I claim is:

1. A method for manufacturing an array of microlenses by the steps comprising:
a. preparing a substrate including a base layer and a plurality of lens pillars located on top of the base layer wherein a plurality of gaps located between the lens pillars;
b. applying a buffer layer to the base layer in an amount sufficient to at least partially fill the gaps between the lens pillars with buffer material; and
c. removing at least a portion of the buffer layer and material from the lens pillars until at least one lens pillar has a lens surface.

2. The method of claim 1 wherein at least one gap is underfilled with buffer material,

3. The method of claim 1 wherein the buffer layer in the gaps has a height essentially equal to the height of at least one lens pillar.

4. The method of claim 1 wherein the plurality of gaps are overfilled with buffer material.

5. The method of claim 1 wherein the buffer material is softer than the lens material.

6. The method of claim 1 wherein the buffer layer is removed in step (c) by polishing.

7. The method of claim 1 wherein the buffer is removed in step (c) by chemical mechanical polishing.

8. The method of claim 7 wherein the chemical mechanical polishing further comprises the steps of:
(i) applying a polishing composition to the exposed surface of the buffer layer; and
(ii) removing at least a portion of the buffer layer from the substrate by bringing a polishing substrate into contact with the exposed surface of the fiber core and thereafter moving the polishing substrate in relation to the exposed buffer surface.

9. The method of claim 8 wherein the polishing substrate is a fixed polishing pad.

10. The method of claim 9 wherein the polishing pad is a fixed abrasive polishing pad.

11. The method of claim 8 wherein the polishing composition includes abrasive particles.

12. The method of claim 8 wherein the polishing composition selectively polishes the buffer layer.

13. The method of claim 1 wherein an antireflective material layer is applied to the substrate between the base and the lens pillars.

14. The method of claim 1 wherein a material layer is applied to the pillar lens surfaces.

15. The method of claim 14 wherein the material layer is an antireflective material layer.

16. The method of claim 1 wherein an optical material is applied to the surface of the substrate following step (c).

17. A method for manufacturing an array of microlenses by the steps comprising:
a. preparing a substrate including a base layer and a plurality of lens pillars including gaps located between the lens pillars wherein the lens pillars have exposed surfaces;
b. applying a buffer layer to the substrate in an amount sufficient to at least partially fill the gaps between the lens pillars; and
c. removing at least a portion of the buffer layer and at least a portion of the lens pillar surface by the further steps of:
(i) applying a polishing composition to the surface of the buffer layer; and
(ii) removing buffer layer from the buffer layer by moving a polishing substrate into contact with the surface of the buffer layer and thereafter moving the polishing substrate in relation to the exposed buffer surface; and
d. continuing to remove the buffer layer and material from the lens pillars until a plurality of one lens pillar have lens surfaces.

18. The method of claim 17 wherein the polishing composition is applied to the surface of the buffer layer at a time selected from before the polishing substrate is moved into contact with the buffer layer surface, after the polishing substrate in moved into contact with the buffer layer surface, or both.

19. The method of claim 18 wherein the buffer material is softer than the lens pillar material.

20. The method of claim 18 wherein the polishing substrate is a fixed polishing pad.

21. The method of claim 20 wherein the polishing pad is a fixed abrasive polishing pad.

22. The method of claim 18 wherein the polishing composition includes abrasive particles.

23. The method of claim 18 wherein the polishing composition selectively polishes the buffer layer.
